(19) United States
(12) Patent Application Publication
(10) Pub. No.: US 2017/0154390 A1
(43) Pub. Date: Jun. 1, 2017

(54) REAL ESTATE INFORMATION EXCHANGE OR TRADING PLATFORM BASED ON BLUETOOTH SIGNALS

(71) Applicant: Wonchan LEE, Seoul (KR)

(72) Inventor: Wonchan LEE, Seoul (KR)

(21) Appl. No.: 14/985,454

(22) Filed: Dec. 31, 2015

(30) Foreign Application Priority Data
Dec. 1, 2015 (KR) 10-2015-0169935

(51) Int. Cl. G06Q 50/16; G06Q 20/32

(52) U.S. Cl. CPC G06Q 50/16; G06Q 20/322

(57) ABSTRACT

A system is provided for exchanging or trading real estate information. The system includes a real estate property, a beacon configured to be installed or attached to the real estate property, and a server on a network. The beacon is configured to transmit short-range signals to a mobile device of a user. The mobile device is configured to receive information on the real estate property from the server over the network and present the information to the user who is determined to be near the real estate property.

### TECHNOLOGY AREAS

The present technology relates to receiving unique values for locations based on Bluetooth signals, providing information about a position and also to a method of exchanging information based on the position and transaction described as the information about how to build the present technology to develop a system and a business model. Bluetooth signals carry each device's information, such as a communication device that is configured to communicate with the system through the pairing over a predetermined frequency band with a frequency of 2.4 Ghz. In the present technology it can be classified as simply beacon Broadcasting. The techniques of the present technology provide further enhancements over an existing location-based service, which combines the location information service based on a particular location, without replacing the battery over a period of time, with a low power in base of the base short-range wireless communication protocol of the Bluetooth (for more than two years) has been made into a system using GPS on the ground, recently folded NFC method, etc., but a beacon are able to use the fact that these terrestrial and information communication distance with the advantage of not confined to the latest distance up to 75 m long-range as well as non-contact It is a method by which the customer can benefit a variety of location-based services.

The present technology relates to an information system construction method and a business model to build such a Bluetooth based short-range wireless communication protocol technology and positioning with beacon positioning technologies through low-power-based property information providing the information of the information providing system.

### BACKGROUND TECHNOLOGY

Underlying technology behind the present technology includes Bluetooth communications in which, personal or private frequency bands are used and communications protocols of persona mobile devices are used, and have many advantages, and beacon based near proximity wireless communications based on Bluetooth signals are used. By generating beacon signals, and receiving, analyzing, and reprocessing the generated beacon-signals, users and administrators can exchange and trade information or data relating to real estate properties, based on locations within a single information system. The present technology described herein provides methods and systems providing unique logic and techniques for an overall information system based on locations (a location based information system). First, beacon signals each comprise a plurality of frames (e.g., beacon frames), in compliance with a telecommunications standard (e.g., Bluetooth). When a smart phone capable of supporting proximity location techniques (e.g., beacons) and Bluetooth 4.0 protocol and devices, comes in contact with a beacon, various information and services may be provided through communications between the beacons and the smart phone. As such, the key aspect of the present technology is to provide a platform through which location based real estate information may be provided and traded, and thus methods, logic and algorithms for implementing the platform are distinctions of the present technology described herein.

In the short-range location-aware technology, with the use of beacons and the Bluetooth 4.0 protocol and a smart phone device to access, a variety of information and services may be provided through mutual recognition between the beacons and the smart phone utilizing the location-based real estate information and transaction system. The core of the present technology is a platform configured to implement the present technology, as well as how to configure the logic and algorithms.

The present technology corrects a signal through a flag value in a signal frequency generator phase of a beacon, creating a server to enhance the accuracy of position on the basis of the corrected signal. At the server, analysis of the received information on the signals from the beacon(s) and reprocessing of the received information are performed, and additional work is needed to provide a service created by a user and a manager software application. According to the present technology, as a component of the property information trading platform, a beacon is installed as an Access Point for each property, the identification (ID) of the signal from the beacon is received at a user's smart phone and a query for information is sent to the server. The server in turn provides requested information to the user's smart device. As such, an administrator who registered real estate information, or a real estate seller, or a real estate agent may register at the server the real estate information, and the prospective buyer may proceed with deciding whether to purchase the real estate after receiving the real estate information registered by the real estate seller and real estate agent. The method and system are provided herein using a short-range Bluetooth communication of this overall property information including the location-based service trading system logic and technology.

### PRIOR ART REFERENCES

### Patent References

None

### Non-Patent References

None

### CONTENTS OF INVENTION

### Problems to Solve

There is a need for a system with enhanced features, such as correcting Bluetooth signals, upon generation of the signals, and improving accuracy of location and performance of the system, having a server to receive, analyze, and reprocess information regarding the beacon signals, and providing services to users and administrator via software applications. The present technology provides a method for constructing a real estate information exchange platform, including installing beacons at each real estate property as access points, receive identification (ID) of the Bluetooth signals from the beacons at a user smartphone, and inquiring about the ID of the signals at a server, which in turn provides information to the user smartphone. The administrator who registered the real estate information, real estate seller, or real estate agent may register the information on the real estate property, and a prospective buyer can receive the registered information that is registered by the real estate seller and/or real estate agent and decide whether to purchase the real estate property. The present technology provides methods, logic, and techniques for construing a location-based real estate information system using the near distance communication methods of Bluetooth technology.

### Means to Solve the Problems

The present technology provides means to solve the above problems by using a protocol called “beacons” in a frequency band of existing Bluetooth signals, exchanging location-based information, and constructing an information system for exchange of the information. A beacon device is configured to send an inquiry to the server, providing identification (ID) information based on location of the real estate property. The location-based information in question, may include an identification (ID) of a server and/or a location ID of the beacon. As such, technology that may be used for implementing the Internet of Things (IoT) as described herein may also be applied to real estate transactions including sales of real estate property, providing people with information on the real estate property stored in one or more servers via mobile devices communicating with beacons and the servers on the Internet. Thus, there may be no need for realtors or prospective buyers to meet and actually visit a property for viewing. For example, the prospective buyer can go directly to the real estate agent who can introduce to the prospective buyer of the real estate that is on sale. Alternatively, the prospective buyers can go to an area when visiting a certain particular area and receive the information on the real without the need to contact a real estate agent who is responsible for the real estate in the area. The prospective buyers can receive the information on the real estate property immediately via the present technology and sales prices can be negotiated through direct communications with the owners in real time of the real estate property in which the prospective buyers are interested. The present technology provides methods, logic, and techniques for constructing a location-based real estate information exchange system using near distance communication methods of Bluetooth technology.

An aspect of the present technology is to exchange the information with each other and providing a price value for the real estate from a database containing various information on the real estate properties, based on the techniques and services described herein using Bluetooth based communications technology. The present technology provides a technique for creating a platform that can provide services for any real estate on earth, using one or more beacons, and communicating the real estate information to mobile devices that come in contact with the one or more beacons using Bluetooth signals. A beacon may be located in any location of the real estate including a split and divided interior space, and the real estate information may be exchanged, thereby enables real-time real estate transactions as needed. Simply, the trading and exchange of position sense or location information may be performed, using the communication methods described herein it can create a user-service system covering all pieces of real estate property including ground, indoor and/or underground pieces of real estate property. The present technology may provide all the seller and purchaser information within the information system in such a way that the prospective buyers and agents/sellers do not need to meet each other directly to show a piece of property of interest via the Bluetooth based technology described herein, which provides location information and related various information on the real estate property via the one or more servers and beacons installed on the real estate properties. The present technology provides such information using a location information server and the detailed Bluetooth technology based logic or algorithms for implementing a real estate business model.

### Effects of the Invention

In conventional technology, when a person desires to purchase a piece of real estate property, the person typically goes online to obtain initial information and obtain detailed information on the real estate property by visiting and meeting with real estate agent(s) or the property owners. Also, the person met the real estate agents and/or the owners to negotiate directly and completed the transactions by means of paper contracts via the real estate office. In contract to the conventional technology, the present technology employing the real estate information transaction platform enables the person to obtain all the information needed within the real estate information platform and directly deal and negotiate online with the owners (or sellers) or the real estate agents, as well as negotiate purchase agreements for the real estate properties.

In other words, using the conventional technology when a prospective buyer had to visit a particular real estate office for a particular piece of real estate on sale, and had to meet with the owner and/or the real estate owner, while through the present technology described herein, the prospective buyer may obtain all the needed information on the real estate property through the real estate transaction platform, and further the prospective buyer may deal and negotiate the terms of a purchase agreement without meeting with the owner or the real estate agent in person. In an aspect of the present technology, the present technology may be extended to or implemented for a national real estate information management system or knowledge base system, as well as for oceanic or geological information.

One of the benefits and/or advantages of the present technology includes enhanced capability for real estate transaction provided to a user, in which given the user's location information and the location information of a piece of real estate, the user is enabled to receive all the information needed for a particular transaction, e.g., real estate transaction, and receive the information services online. The present technology enables people to exchange various information, deal and negotiate the deals online within a single platform, based on real-time communications and exchange of information among interested parties, while the conventional technology did not allow the user to obtain the needed information with ease, such as detailed information on a physical real estate property that is located at a specific location. For example, a certain technology based on global positioning signal (GPS) may not provide sufficiently detailed information on the real estate property such as one located in a basement of a building or inside a building, and another technology based on NFC is often limited to a close distance such as 10 cm, which requires close contact or near contact with a device for receiving information on the device.

The disclosed technology, on the other hand, provides an example of a Bluetooth signal based technology and provides a method and a system for building a location based information platform for real estate. In one implementation, the disclosed technology includes correcting beacon signals, assigning and retrieving an identification (ID) of a particular location, and based on the identification of the particular location, providing an information system to a user over a network (or online) about a transaction of the real estate property situated at the particular location. As such, the disclosed technology also provides a related business model, enabling the enhancement of the real estate transaction.

### BRIEF DESCRIPTION OF THE DRAWINGS

FIG. 1 illustrates an example of a real estate contents dealing platform structure.

FIG. 2 illustrates an example of a real estate contents dealing platform algorithm.

FIG. 3 illustrates an example of a real estate contents dealing platform detail logic.

FIG. 4 illustrates an example of a real estate contents dealing platform flow chart.

FIG. 5 illustrates an example of a real estate contents dealing platform block diagram.

### DETAILED DESCRIPTION

The present technology discloses, based on Bluetooth signals in telecommunications engineering, methods, logic, and business models for constructing a real estate information exchange or trading system, configured to correct signals of wireless communications protocols, assign an identification (ID) value to the signals, to store, via the ID value, information relating to the real estate property in a database, and based on stored information provide various types of information on a real estate property to users for doing business with each other.

Typically, there are many communications protocols for near distance or proximity communications. One of the most widely used technologies is a near distance wireless communication called a near field communications (NEC). For example, NFC communications method is often used in a near distance, as in NFC cards which communicates in the near distance within 10 cm without contact or in contact with a special device. The present technology describes a method of building a real estate location based information exchange or trading system and its business model. The real estate location based information exchange or trading platform is configured to exchange various information based on real estate location and location of beacons, which includes a simple frequency transceiver circuitry, miniaturization, light weight and low power.

An overall business model is described herein first. A beacon is installed or attached to a real estate property which is registered via software as a property for sale, (when the real estate is a building the beacon is attached to the building, and when the real estate is a parcel of land, the beacon is attached to a pole or a road sign). A prospective buyer who visits the real estate property sees on a website information regarding the real estate (blogs, image, video, etc.) that is entered by an administrator, decides to enter into a contract or leaves comments the website (real estate visit comments, due diligence evaluation, etc.), and the administrator may send messages to the prospective buyer at site in real time, providing additional detailed explanation, changes in the market prices, or prices and/or other terms of negotiation regarding the real estate property.

In other words, regarding the real estate property for sale, there is no need for the real estate agent or real estate owner to meet the prospective buyer who are visiting the real estate property and explain in detail and negotiate terms with the prospective buyer. Instead, the real estate agent and/or the real estate owner may sit in a realtor's office and communicate online with a number of perspective buyers concerning the real estate property, based on location.

The real estate information exchange or trading platform includes: (i) an application or a website for registering a real estate property and providing information relating to the real estate property; (ii) beacon devices; and (iii) a location-based real estate information exchange platform. The location-based real estate information exchange platform includes: (ii) a contents management server (CMS) for the information received via the application or the website, (ii) an output part for outputting to a user's smartphone contents based on the entered information in the CMS, and (iii) a processing part for handling location-based communications between the administrator and users (or customers).

In accordance with aspects of the present technology, information on a real estate property is registered (monthly fixed fee and installation fee are received) at the location-based real estate information exchange platform, the system administrator installs beacons to the real estate property for sale, and assign an ID value to the real estate property, and information (or “contents”) regarding the real estate property may be entered or uploaded via the application or the website by the real estate agent or the real estate owner.

The application or website may include a structure in which upon registration of the real estate property online, the system administrator (which is also interchangeably referred to herein as “real estate registrar”) may generate and issue user IDs. A user ID may be used to register the real estate property for sale, and when installation of beacons is requested, register the contents that will be distributed to users via the beacons, and communicates in real-time with the users (which is interchangeably referred to herein as the “prospective buyer,” or “real estate purchaser”) who is at the real estate property, regarding the contents or real estate information that has been registered online.

The IDs of customers or prospective buyers may be used to search for a real estate property for sale (e.g., beacon real estate scanner) and may freely leave any messages online on the webpage or to the real estate administrator (which is also interchangeably referred herein to as “integration manager”) about a particular real estate property with beacons.

In other words, there are many identity groups or levels including integration manager, real estate registrar, real estate purchaser (a total of three levels of identity (ID) groups), and there is a super-administrator user ID group at the top level that can control everything. When a platform system is provided to a real estate business, a platform package, including the Super Administrator is provided to a large real estate company. For a medium-sized real estate company, the super-administrator user ID group is managed by the platform provider, and up to a middle manager ID group is provided to the medium-sized real estate company. For a small real estate company up to the middle manager ID group is managed by the platform provider, and the small real estate company issues user IDs and manage customer user IDs only.

In other words, depending on a size of a real estate company, manageable ID levels may be classified and the classified ID levels may be provided as management of customer IDs, management of lower real estate companies, and management of the overall platform. The real estate information exchange or trading platform described herein includes: (i) a CMS server for information or data entered via an application or webpage, (ii) an output part for outputting or sending the contents to user's smartphones based on the received information at the CMS, and (iii) a processing part for handling location-based communications between the real estate agent/owner and the users. A detailed description of an example implementation of the present technology is provided below in reference to various figures.

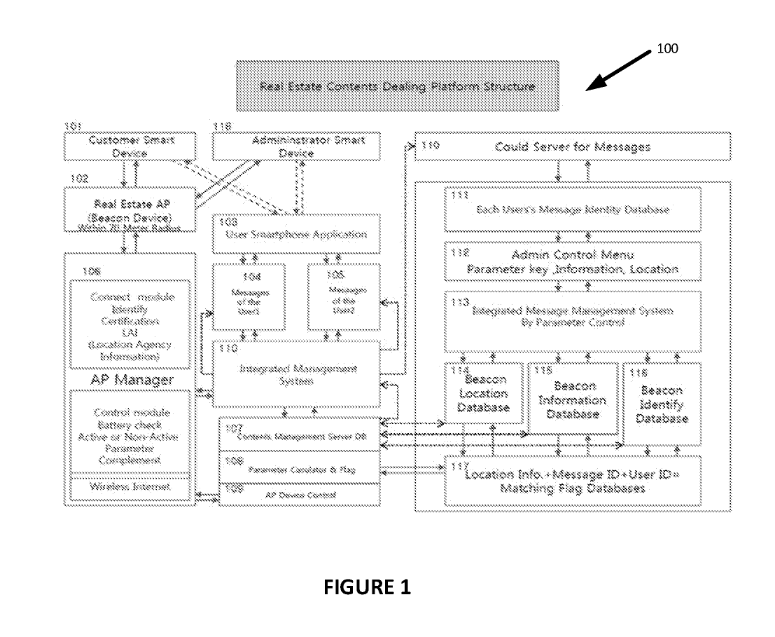

FIG. 1 illustrates an example of a structure of the real estate information exchange or trading platform 100 (which is interchangeably referred to as “Real Estate Contents Dealing Platform Structure”). When a smart device 101, such as a smartphone of a user, comes within a close proximity of a beacon installed at a real estate property, e.g., real estate AP (beacon device) 102, a user smartphone application 103 identifies an ID value. An integrated management system 110 (and 104 and 105) receives the content for the customer smart device 101, and sends the content to the user smartphone application 103 via the user smartphone application 103(and 104 and 105). A contents management server database 107 is configured to manage contents and is responsible for inputting and outputting information from a database. The contents management server database 107 is further configured to identify an ID of content based on outputs of a parameter calculator and flag 108. An AP manager 106 identifies and matches the outputs of the parameter calculator and flag 108 with identified values of the beacon installed at the real estate property, in which the identified values indicate statuses of a battery check, an active or inactive status check of the beacon. Typically, contents of the real estate information may be stored in a storage medium such as a cloud server for messages 110, as information to be retrieved and updated. The cloud server for messages 110 performs a cross-matching of ID values of a customer (or user), real estate property, and corresponding contents (as at 111 and 112), and provide key values which are adjusted. In other words, the administration control menu (parameter key, information, location) 112 performs a role of matching, identifying and providing information that is going to be a prospective buyer by a real estate agent. Data for the information include information stored in a beacon location database 114 (storing information on locations of beacons), a beacon information database 115 (storing information on beacons), and a beacon identify database 116 (storing information on beacon ID values). Based on the data, e.g., the beacon location database 114, the beacon information database 115, and the beacon identify database 116, a component 117 (e.g., the location info+message ID+user ID=matching flag databases) matches the location information, content ID and user/customer ID into a flag value, and provides to a particular user information specific to a particular real estate property. In accordance with this structure of the design, user smart devices which use the application can individually cross-match each of user IDs, content IDs, and real estate property IDs. That is, each user may have individual capability to exchange contents among many users, and may have capability to share the contents. Put another way, in providing social networking services, users may create an online space or room for sharing the contents or information with each other, and two users may share the contents privately among the two. Additionally, the users may make the contents accessible to everyone. In other words, the platform described herein is a system with a limitless expansion possibility because the contents, users, and beacons installed at the real estate properties can be individually customized.

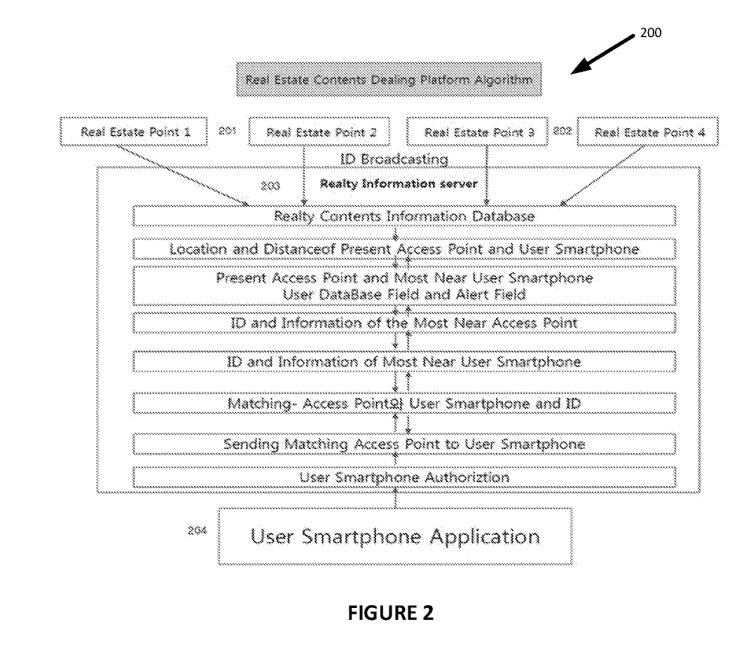

FIG. 2 illustrates an example of an algorithm 200 for the real estate information exchange or trading platform (which is interchangeably referred to as “Real Estate Contents Dealing Platform Algorithm”). The example algorithm illustrates how information regarding a particular beacon installed at a particular real estate property is handled or processed at the real estate information exchange/trading platform. Beacons 201 and 202 installed at a real estate property continuously broadcast particular ID values relating to locations of the beacons. When an application which receives the particular ID values broadcast from the beacons, the application, sends the received particular ID values to a real estate information server (e.g., realty information server 203). Matching of the particular ID values and the real estate information content IDs is based on contents which are stored in a content database. To retrieve the contents from the content database, distance and location coordinate information between a current access point (AP) and a user smartphone are determined and used. Here, identified information returns ID values and information of presently closest AR which becomes pairing information for the ID value and information of currently closest smartphone. As such, the AP (beacon) installed at the real estate property and the smartphone of the user are matched (or paired), and as a result, exact contents that are relevant to particular coordinate values of the locations of the smartphone are provided to the user who are visiting the particular real estate property and are located at a specific location. Further, if user verification is performed by a user application installed as an app, as to whether the user is a prospective buyer, after a successful verification, all the information may be provided to the user via an application installed on the user's smartphone or mobile device.

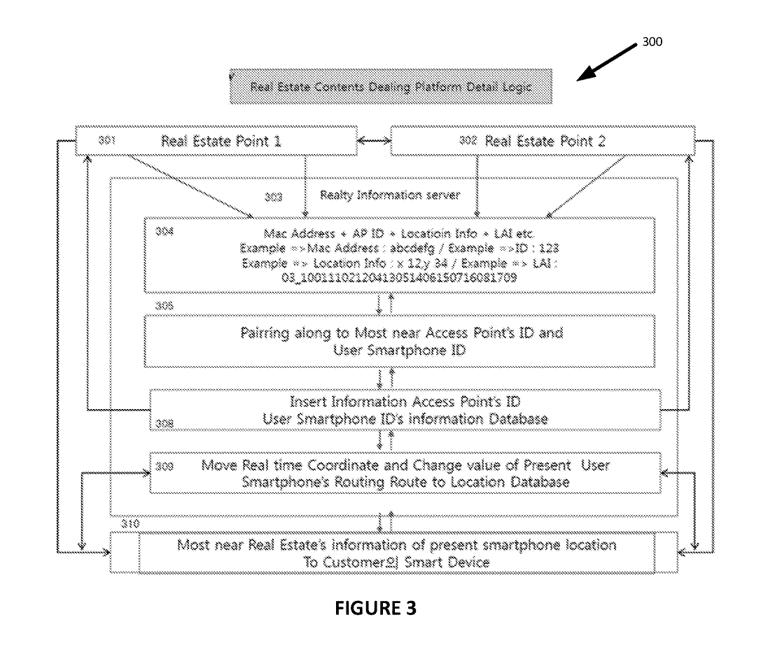

FIG. 3 illustrates an example of a detailed logic 300 for the real estate information exchange or trading platform (which is also interchangeably referred to as “Real Estate Contents Dealing Platform Detail Logic”). In FIG. 3, beacons 301 and 302 that are installed at a real estate property send their ID values to the realty information sever 303, and the received ID values are input to a component 304 configured to parse information received from the beacons installed at the real estate property, and input or store into respective databases. Here, an example algorithm such as reframing techniques of the beacon signals, which are techniques for correcting signals, is used and is configured to determine or calculate current absolute location of a user who is visiting the real estate property and absolute locations of the beacons that work as APs. The information of the user and the information of the beacons are processed at 304, and are used to match the ID of the closest AP on a path of the user smartphone with the ID value of the user smartphone, as a pair, at 305. Preregistered real estate contents data of the matched ID of the closest AP is stored in an information database corresponding the ID of the user smartphone, at 308. The stored data and real-time coordinate values of a moving path of the present user smartphone and their changes are stored in a location database of the user smartphone, at 309. In this way, at 310, no matter where the present user is at a particular place of the real estate property, real estate information (when the real estate property is a house, this includes an interior of the house) of a closest location from the particular place may be transmitted to the user smartphone.

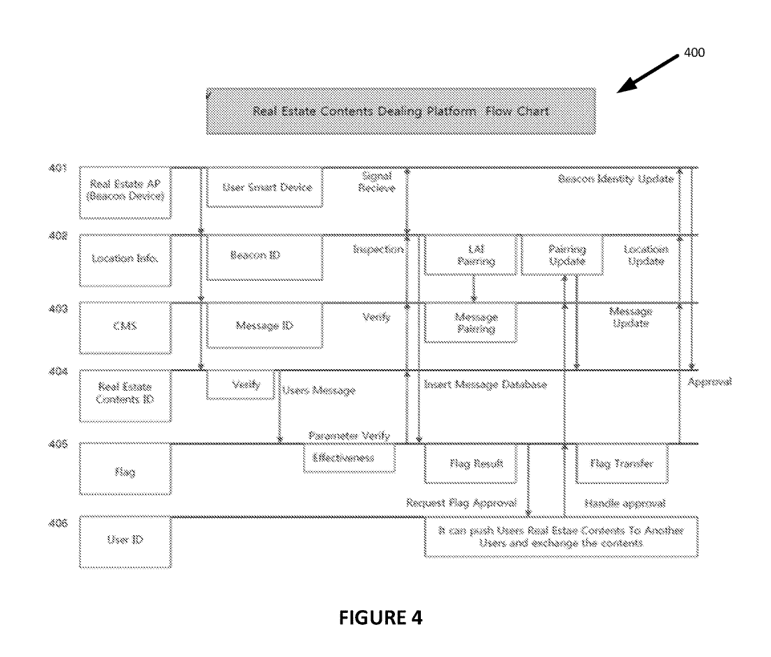

FIG. 4 illustrates an example of a flowchart 400 for the real estate information exchange or trading platform (which is also interchangeably referred to as “Real Estate Contents Dealing Platform Flow Chart”). In FIG. 4, at 401, when Bluetooth signals are broadcast via the beacons installed at the real estate property, the user smartphone receives the Bluetooth signals, and based on ID values of the beacons, at 402, location values of the real estate property are identified and verified. At 403, the contents management server (CMS) searches for ID values of the information messages. At 404, the searched ID values of the information messages are verified as the ID values of the real estate information, and transformed into a parameter(s) which is matched with a flag value that defines an ID of a particular user at a particular location, at 405. At 406, the particular user moves relative to a particular real estate and continuously updates ID values of the beacons via the beacon identify update shown at 401. The updated ID values of the beacons are used in updating the pairing via the signal correction algorithm based on location agency information (LAI), and are used in updating the ID values of the real estate property information messages, as shown at 403. In other words, using a process similar to the one described above, flag values may be changed, at 405, and the flag values continuously change, based on the user and locations, and are updated as key values. In conclusion, the user ID value, at 406, may be used to cross match, via updating the flag values, the location ID, real estate information ID and user ID for exchange of the information. In this way, the user who received the real estate information from the beacons installed at the real estate properties during a movement of the user may push the received real estate information to other user(s) and may exchange the real estate information with other user(s).

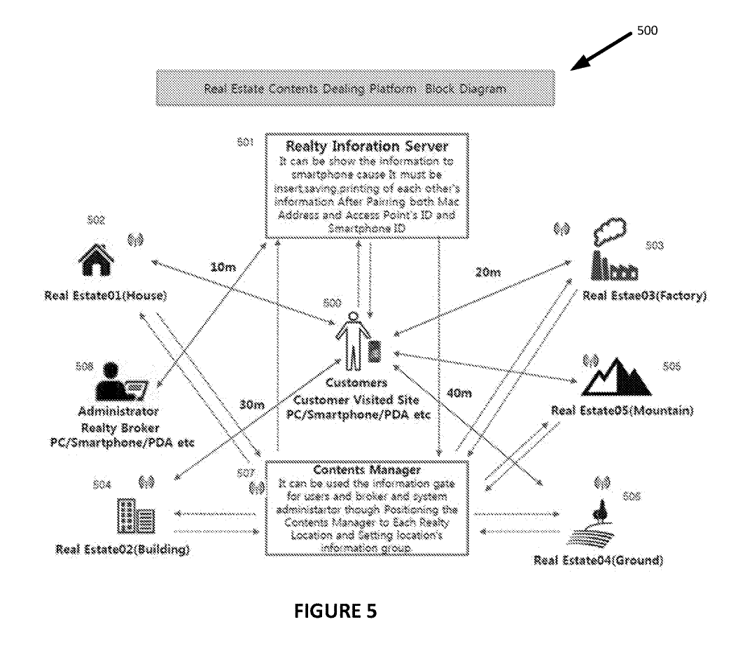

FIG. 5 illustrates an example of a block diagram for the real estate information exchange or trading platform, which depicts a service structure of the real estate information exchange or trading platform. Received Bluetooth signals at a realty information server 501 are used in pairing of MAC address of the device itself, ID of an access point, and ID of a user smartphone. Also, the received Bluetooth signals are used in searching and matching ID of the real estate information and in determining by an administrator an input, storage, and output of the contents information regarding access point(s), based on the matched combination of IDs. The real estate contents information is then used in providing a user with information relevant to the real estate property based on a place the user moves (from one real estate property to another). The information provided is location-based real estate information which can be used in communications among users or trading between the real estate seller and the real estate buyer. In FIG. 5, for example, the real estate property may be a house 502, a factory 503, a building 504, a mountain 505, and a parcel of land 506. With respect to all of the examples of the real estate properties, when the user 500 visits a location of a real estate property, information relevant to the real estate property may be provided based on the closest or the remote criterion. Explained again, a real estate agent or a real estate owner 508 determines whether to input, store, or output real estate data for each of 502, 503, 504, 505, and 506, to/from respective real estate databases, and a customer who visits in person the real estate property may receive in real-time real estate information and any changes that are relevant as the customer moves along a route. Further, the customer 500 and the administrator 508 may exchange information in private through pairing of each other, may send to other people, and share public information with all the users from other places. A contents manager 507 may group real estate properties based on location, and provide real estate information to all users in a region. For example, if a beacon is installed in a real estate property in Gangnam-gu, Seoul, then Gangnam-gu may become one contents group and the real estate information on the real estate property may be shared with smart devices with applications. Further, the contents manager 507 may become a gateway for trading real estate information among users in the Gangam-gu group.

As described herein, in accordance with aspects of the real estate information exchange or trading platform, beacons are installed or attached to a real estate property at a particular place, and based on Bluetooth signals from the beacons, a real estate agent or a real estate owner may share with users, based on location, information on the real estate property without meeting in person with a prospective buyer, and do business with the prospective buyer. In addition, the present technology, based on the Internet of Things, enables that the real estate agent or the real estate owner may exchange information on site where the real estate property is located, and negotiate and do business with the prospective buyer.

The present technology described herein, based on Bluetooth and beacon technology, corrects Bluetooth signals and based on the corrected Bluetooth signals, create IDs for real estate properties and users and pair them as new units of information. Based on the units of information, the present technology enables exchange of real estate information in real-time and deals among users. Further, beacons are installed or attached to the real estate property (if the real estate property is a building, the beacons are installed or attached to the building, or when the real estate property is a parcel of land, the beacons are installed or attached to a pole or a road sign), and information on the real estate property for sale (blogs, images, videos, etc.), which has been entered by an administrator, may be received at users who visit the real estate property. As such, the users may see the information on the real estate property on their devices and decide to enter into a contract for purchase or exchange information with others, or communicate with the administrator (a real estate agent or a real estate owner), and the administrator may send or receive other information in real-time to/from the user who is at the site, such as more detailed explanation, changes market prices, prices, or other negotiation items. In other words, in an aspect of the present technology, there is no need for the real estate agent or the real estate owner to meet with a prospective buyer and go to a location of a real estate property to explain and negotiate the deal. Rather, the real estate agent or the real estate owner may sit in the office and communicate with many prospective buyers online regarding real estate properties based on locations, and thus there is no need for the prospective buyers to visit the realtor's office and go together to location of the real estate property. In accordance with the present technology, prospective buyers, real estate agents, and real estate owners all exchange information on a real estate property and do business with each other, without having any in-person meetings, and they may enter into a purchase agreement using software after verification of each other. The present technology may also apply to national or local real estate management system (real estate registrar system, knowledge system, geological system, oceanic system, etc.) and enable exchange and sharing of information that is relevant to a local area without going to a place where a real estate property is located. The present technology described herein provides methods, logic, algorithms, and business models for a location-based real estate information exchange or trading platform based on the Internet of Things.

### EXAMPLE

The present technology may be implemented as actual applications on smartphones or PC software.

### INDUSTRIAL APPLICABILITY

The present technology may be implemented in a packet based technology including the Internet, a network or other networks capable of supporting Internet Protocol (IP) based devices or equipment.

### REFERENCE NUMERALS

Provide descriptions of reference numerals shown in the drawings.

### Accession No.

List accession numbers of microbes that are listed in the description.

### Sequence Listing Free Text

Repeat and list as necessary the free text appearing in the Sequence Listing attached to the specification.

1-7. (canceled)

8. A system for exchanging or trading real estate information, comprising:
a real estate property;
a beacon configured to be installed or attached to the real estate property, the beacon being configured to transmit short-range signals to a mobile device of a user; and
a server on a network, wherein the mobile device is configured to receive information on the real estate property from the server over the network and present the information to the user who is determined to be near the real estate property.

9. The system of claim 8, wherein the real estate property is on sale and the user is a prospective buyer who is visiting location of the real estate property.

10. The system of claim 8, wherein the server is configured to:
receive and store contents regarding the real estate property input by a real estate agent, an administrator, or a real estate owner;
create the information on the real estate property for transmitting to the mobile device of the user, based on the contents; and
enable communications online in real-time between the user and the real estate agent, the administrator or the real estate owner who is not with the user at the location of the real estate property.

11. The system of claim 8, wherein the server is further configured to allow the user to post a message comprising user comments on the real estate property.

13. The system of claim 11, wherein the server is further configured to allow the user to store the message in storage coupled to the server for a second user who visits the real estate property, and when the second user comes in a coverage area of the beacon attached to the real estate property, the message left by the user is retrieved and transmitted to a mobile device of the second user for presenting the message to the second user.

14. The system of claim of 8, wherein the short-range signals from the beacon comprise Bluetooth signals including identification (ID) information of the beacon.
